(19) United States
(12) Patent Application Publication
(10) Pub. No.: US 2024/0346288 A1
(43) Pub. Date: Oct. 17, 2024

(54) NEURAL NETWORK ARCHITECTURE

(71) Applicant: Arm Limited, Cambridge (GB)

(72) Inventors: Maxim Novikov, Manchester (GB); Puneet Singh Matharu, Manchester (GB); Tarush Bansal, Cambridge (GB); Alexis Leonardo Lluis Gomez, Chelford (GB); David Hanwell, Sale (GB)

(21) Appl. No.: 18/301,921

(22) Filed: Apr. 17, 2023

(51) Int. Cl. G06N 3/045; G06N 3/082

(52) U.S. Cl. CPC G06N 3/045; G06N 3/082

(57) ABSTRACT

A first neural network generates a first output tensor based on an input tensor, the first output tensor comprising values to impart an effect to one or more features in the input tensor. A second neural network generates a second output tensor based on the input tensor, and the effect to be imparted to the one or more features is modulated, based at least in part, on the second output tensor.

### FIELD

The invention relates generally to neural networks, and more specifically to a novel neural network architecture.

### BACKGROUND

Processing computer information has evolved from simple storing of business transaction records or documents to storing, organizing, and processing more complex content such as photos, videos, and music, such as are captured and shared by the millions every hour by smartphone users. In addition to processing complex captured information such as video or photos, artificial intelligence systems are increasingly capable of creating written text or artwork that closely mimics content created by people, and can process various inputs to create or modify such works. One such example area of innovation is the use of artificial intelligence, such as a neural network, to recognize objects or features in photos or video, and to change or enhance the recognized objects. Some filters are designed to process an image to remove noise or aliasing, to improve contrast or color, or to interpolate or upscale an image using intelligent recognition of image features such as object edges. Other filters are designed to identify and process other features that are increasingly complex, such as face filters designed to hide minor blemishes or wrinkles.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 is a diagram of a system to process signals, as may be used to practice some embodiments.

FIG. 2 is a block diagram of a signal processing and/or filtering architecture, consistent with an example embodiment.

FIG. 3 shows a signal processing and/or filtering architecture, consistent with an example embodiment

FIG. 4 is a flow diagram of a method of using a signal processing and/or filtering architecture to process an input signal, consistent with an example embodiment

FIG. 5 is a schematic diagram of a neural network, consistent with an example embodiment.

FIG. 6 is a schematic diagram of a convolutional neural network, including a fully-connected feed-forward section configured to classify an input signal, consistent with an example embodiment.

FIG. 7 is a schematic diagram of a computing environment in which neural network architecture blocks are employed, consistent with an example embodiment.

FIG. 8 shows a block diagram of a general-purpose computerized system, consistent with an example embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Other embodiments may be utilized, and structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

Artificial intelligence techniques such as neural networks are often used to process complex information such as images. Some such applications seek to improve the image quality by removing noise or aliasing, improving contrast or color, or interpolating or upscaling an image using intelligent recognition of image features such as object edges or shapes. Other filters are designed to identify and process other features that are increasingly complex, such as face filters designed to hide minor blemishes or wrinkles that have become common on social media sites and in standalone apps such as Facetune. Artificial intelligence tools such as neural networks can similarly improve the loss of detail due to image or video compression, such as de-mosaicing or de-interlacing encoded video or images, or can be used to process artificially-generated content to appear more life-like or realistic.

But, demand for such applications is often driven by consumer devices that have limited computational power, limited battery life, and other constraints. Further, consumer applications often require real-time or near real-time processing of complex data such as video or images to provide a desirable customer experience, limiting the extent to which artificial intelligence techniques can be employed in a way that is beneficial to an end user experience. Improving the speed and efficiency of artificial intelligence processing of complex information, such as neural network processing of image or video data, is therefore an important area of research and development in hardware and software implementation of artificial intelligence.

Some examples presented herein address these and other challenges by providing an improved signal processing architecture comprising two or more neural networks or two or more data paths within a neural network to process complex input signals such as images. In a more detailed example, a first neural network may receive an input signal such as an image or video frame, and detect one or more features of the input signal such as edges, noise, or other such features. A second neural network may perform filtering and/or processing on the input signal, such as edge smoothing or filtering, de-noising or de-mosaicing, resampling, or other such functions. Output signals of the first and second neural networks may then be combined, such as by multiplying output signals of the first and second networks together such that the filtering or processing of the second neural network is selectively applied to the one or more features identified by the first neural network. In a further example, a product of output signals for first and second networks may be added to the input signal, resulting in a modified version of the input signal in which the second neural network's filtering function may be selectively applied to features detected by the first neural network. In an alternate example, the first neural network may be used to selectively apply filtering or processing of at least one of multiple other neural networks, such as to increase contrast in shadows as processed in a second neural network and highlights as processed in a third neural network. Combining outputs in such a manner reduces the input size for the third neural network. Other examples may comprise a single neural network architecture having two or more discrete data paths within the neural network that are then combined, such as by element-wise multiplication of the outputs of the discrete data paths within a larger single neural network, producing a similar result as using different neural networks.

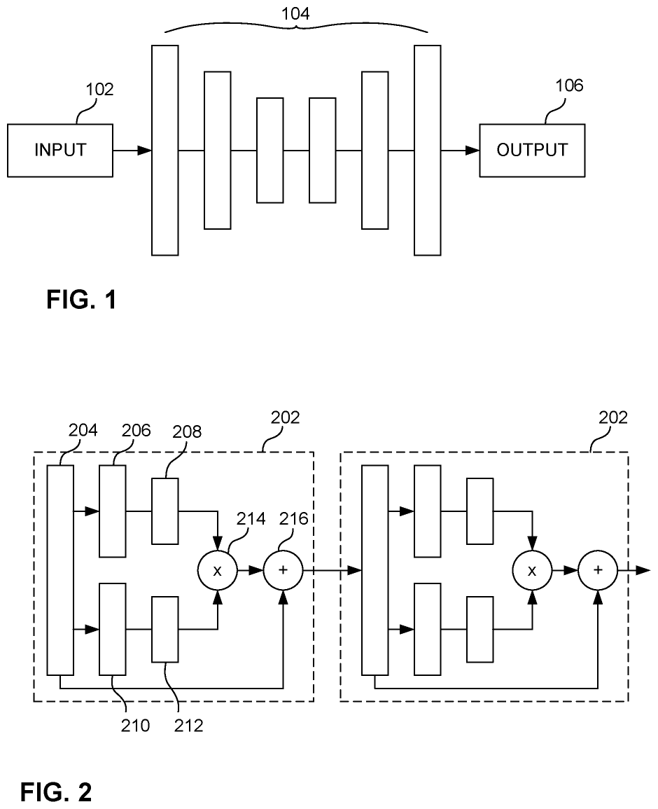

FIG. 1 shows a signal processing and/or filtering architecture, as may be used to practice some embodiments. Here, an input signal 102 is fed into processing stages 104. The input in various examples comprises data having various values, parameters and/or states encoded therein, such as an image having definable objects, edges, colors, and other characteristics, or other values, parameters, states, etc., such as stock market information, healthcare records, or weather conditions to be used in recognizing or predicting things such as stock price movement, health risks, and future weather. In a more detailed example, an image comprising multiple dimensions or channels is provided, including an x coordinate and y coordinate for each pixel, as well as red, green, and blue luminance channel values for each pixel. This information may be preprocessed provided to a network of nodes arranged in layers as shown at 104.

Processing stages 104 in this example has six layers. In one embodiment, one or more such layers may comprise a group of nodes connected to nodes in previous and subsequent layers. In some examples, nodes in a layer may be “fully connected,” or connected to every node in a preceding and subsequent layer, while other processing architectures such as convolutional neural networks may have more complex connection structures linking layers and nodes. A node in a particular layer of processing stages may implement an activation function, which may be determined, at least in part, by learning processes such as backpropagation of errors in output detected using ground truth observations. A fully trained network may comprise static coefficients (or tensors) associated with nodes and/or layers, which along with an activation function define how an output value(s) of each node is derived from input value(s). Activation functions in various examples may be linear, such as multiplying an input by a static coefficient, or nonlinear, such as using logarithmic or exponential functions of the node's inputs along with node coefficients or tensors to derive the output.

FIG. 2 shows a block diagram of a signal processing and/or filtering architecture, consistent with an example embodiment. Processing stages 202 in this example may perform discrete functions, such as upscaling or interpolation, edge sharpening, de-noising, de-mosaicing, or other functions, just to provide a few examples. In a more specific example, each processing stage 202 may comprise one or more neural networks implemented in hardware, which in various examples can be preconfigured for a particular purpose or user-programmable to perform user-specified functions.

In a processing stage 202, an input tensor, such as including image signal values defined for x and y coordinates R, G, and B luminance values is received and is latched to input tensor 204. In other examples, the input tensor may comprise values for other image frame formats (e.g., YUV, RGBIr, RGGB, RCCY, RCCB and RCCC), other feature maps, and/or other data types without deviating from claimed subject matter. Input tensor 204 may be provided to neural network layer 206, which in turn is connected to one or more subsequent neural network layers 208. Input tensor 204 may also be provided to neural network layer 210, which is coupled to one or more subsequent neural network layers.

Neural network layers 206 and 208 in the example of FIG. 2 may be configured or trained to perform a first function, such as feature detection within input tensor 204. In a more detailed example, neural network layers 206 and 208 may perform specific functions such as finding object edges, finding image objects such as letters or faces, or finding image or video compression artifacts, just to provide a few examples. Neural network layers 210 and 212 in this example may be configured to perform a signal processing and/or filtering function, such as interpolation, de-noising, de-mosaicing, and/or the like. An output tensor of neural network layer 208, comprising detected features of input tensor 204, and output tensor of neural network layer 212, comprising filtering or processing the input, are combined at 214 such as by element-wise multiplying values in respective output tensors of neural network layers 208 and 212. In this example, neural network layers 206 and 208 together form a first network, for example, a detection network, and neural network layers 210 and 212 form a second network, for example, an interpolation network. In other examples, the number of layers and architectures of the networks may differ.

In a particular image processing example, a result multiplication at operation 214 may comprise signal processing and/or filtering as generated by the neural networks 210 and 212 applied to only those areas of an input image detected by neural network layers 206 and 208. A result of multiplication and/or combination of operation 214 may then be added to input tensor 204 at adder 216, applying a signal processing and/or filtering function previously constrained to select features (e.g., select objects and/or features within an image space to an original image), resulting in output features with signal processing and/or filtering applied only to detected features (e.g., objects) within input tensor 204. This output tensor may then be provided in this example to a subsequent processing stage 202, which may perform another signal processing and/or filtering function. Each subsequent processing stage 202 in the example of FIG. 2 may also be known as a CollapseNet layer, in that it performs a function of what historically would have taken a significantly larger and more elaborate neural network architecture to achieve.

In one example of a neural network, spatial resolution of features map of an input tensor, such as image signal intensity values associated with pixels in an image frame, may be mapped to features having a reduced resolution in intermediate stages of the neural network. Such a reduction in resolution of features may occur, while a number of channels increases, to produce an abstract representation of features in the input tensor. Features in the reduced spatial resolution may then be mapped to features in an increased resolution at subsequent layers while a number of channels is decreased. This may generate, for example, output features (e.g., image) based on the abstract representation. Activation functions between layers may be nonlinear, facilitating an abstraction of features in an input tensor and recognition of features, but the number of neural network layers, nodes, and channels required to produce the desired output result in a huge amount of information that must be processed and passed in and between layers of a traditional convolutional neural network architecture.

Neural networks and layers of FIG. 2 may perform respective functions particularly efficiently in part due to isolating functions of feature detection and filtering into different networks, and in part due to improved nonlinearity. More specifically, multiplying values of output tensors of respective neural networks 208 and 212 may introduce a significant nonlinearity, allowing fewer neural network layers having fewer nodes in neural networks of FIG. 2 than in a typical signal processing and/or filtering neural network architecture to produce a desired result. Efficiencies gained by a reduced size and improved nonlinearity in combining values of output tensors of neural network layers 208 and 212 may be further enhanced by an ability of processing stage 202 to perform multiple functions at the same time by concurrently executing two different neural networks having different objectives in parallel. Neural network layers 206-208 and 210-212 may in one example, be convolutional neural network layers, but in other examples may be any type of neural network as are commonly known or may become known in the art.

In a further example, at least some functions of processing stage 202 are pipelined, or are generated using un-clocked processing in which an output value of a processing element that is passed to a subsequent processing element may change responsive to a change in an input value. A state of neural network layer 206 may change responsive to a change in an input tensor. A state of neural network layer 210 may similarly change responsive to an input tensor. Output tensors of neural network layers 206 and 210 change in response to change in input tensors, resulting in changes to values of the output tensors provided neural network layers 208 and 212. States of neural network layers 208 and 212 may similarly change in response to input tensors, generating output tensors that are not dependent on the output tensors of neural network layers 206 and 210 being clocked or latched. Output tensors of neural network layers 208 and 212 may be directly provided to a multiplier that serves to combine values of the output tensors of neural network layers 208 and 212 by element-wise multiplying together, which may then be provided immediately (e.g. without waiting for a clock signal to latch the multiplier output) to adder 216, in which the product of operation 214 is added to input tensor 204. A resulting sum is in this example shown as being provided directly to a subsequent processing stage 202. Using un-clocked or pipelined processing in neural network block elements such as in neural network layers 206-212, operation 214, and adder 216 may enable faster generation of a stable neural network output tensor than clocking and latching each element or stage, improving the speed and efficiency of processing stages 202.

Although processing stages 202 of FIG. 2 concurrently execute multiple networks to perform different functions in parallel to generate outputs that are combined to generate output tensors of the processing stage 202, other examples may include one or more additional neural networks (not shown). In one such example, neural network layers 206 and 208 may be optimized to detect vertical edges of objects while neural network layers 210 and 212 may be optimized to detect horizontal edges of objects, and one or more additional neural networks (not shown) may perform a filtering function such as blur or interpolation. Output tensors of neural network layers 208 and 212 may be combined by adding values of the respective output tensors to produce an output signal that detects both vertical and horizontal edges, which may then be multiplied by value(s) of an output tensor of the one or more additional neural networks (performing a filtering function) before being added to an input tensor.

In a similar alternate example, one or more first neural networks may perform feature detection such as object edge detection while one or more second neural networks may perform a first filtering function such as interpolation. One or more third neural networks may perform a second filtering function such as de-noising or blurring. An output tensor of the one or more first neural networks may be used to determine selective application of filtering functions of the one or more second neural networks and/or the one or more third neural networks. Such selective application of filtering functions may comprise applying interpolation from the one or more second neural networks where edges are detected and applying de-noising from the third neural network where there are no edges. In another example, the interpolation by the one or more second neural networks and de-noising by the one or more third neural networks may be applied to only the areas of the input image in which the one or more first neural networks detect objects or features. In an alternate example, interpolation by the one or more second neural networks may be applied to only the areas of an input tensor in which the first neural network detects objects or features and the third neural network's de-noising may be applied to an entirety of an input tensor.

A feature detection output value of the one or more first neural networks in another example may be provided as an output tensor processing stage 202, such as for use in one or more subsequent processing stages. The input 204, such as the original image input in an image processing application, is similarly provided as an output to other neural network blocks 202 in other examples. This may enable processing stages 202 to work with features detected in an input tensor, and may enable such processing stages 202 to employ an input tensor in various signal processing and/or filtering operations as may be beneficial. For example, if processing stage 202 of FIG. 2 does not need to do feature detection because it can apply its filtering to features found in first neural network layers 206 and 208, it may be able to more quickly filter or process the other data it receives as an input or leverage its second neural network for other purposes such as additional filtering, feature detection, or processing.

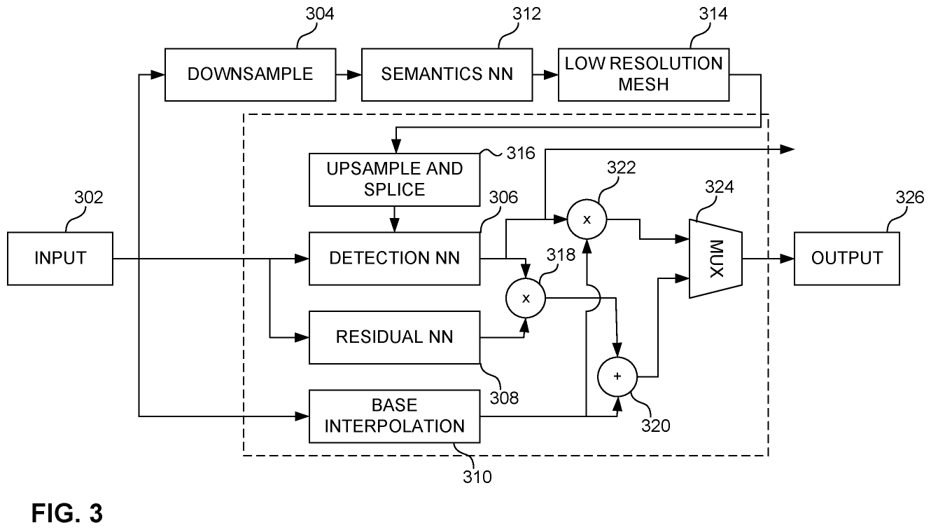

FIG. 3 shows a signal processing and/or filtering architecture, consistent with an example embodiment. In an embodiment, this particular example of a commercial image processing application of a neural network block illustrates how a signal processing and/or filtering architecture may implement a multi-purpose neural network block configured to perform de-noising, de-mosiac, mesh shading, color grading, tone mapping, and other such image processing functions with a common hardware architecture. An input tensor 302, such as an image or a frame from a video, may be provided to a downsampling filter 304, as well as to a detection neural network 306 and a residual neural network 308. A separate base interpolation filter 310 (which in a further example may comprise a neural network) may interpolate values of an entire feature map to a desired output resolution. Downsampling filter 304 may be coupled to semantics neural network 312 and low resolution mesh filter 314, and to upsample and splice filter 316. Output values of the detection neural network 306 and residual neural network 308 may be multiplied together in multiplier 318, and added to the interpolated or scaled image provided by base interpolation filter 310 at adder 320. Values of an output tensor of detection neural network 306 may be multiplied such as by a feature weighting coefficient at multiplier 322, and provided to multiplexer 324 along with an output value of adder 320. Interpolated and filtered features generated at adder 320 and/or the feature detection value generated at detection neural network 306 and scaled at multiplier 322 may then be selectively provided as a portion of output tensor 326, either as an input tensor of a subsequent neural network filter block or as a final processed output tensor.

In some embodiments the neural network block of FIG. 3 may be implemented at least in part in hardware, such as having its neural network coefficients hard-coded or having a structure that is fixed in hardware but with programmable coefficients. For example, fixed discrete elements such as resistors and transistors may be used to build the neural network nodes so that they permanently implement the same trained neural network design and configuration. In other embodiments, one or more of the neural networks such as detection neural network 306 and residual neural network 308 are configurable, such as by loading a set of trained neural network coefficients into the neural network hardware to implement a desired neural network to perform selectable or programmable detection and/or filtering functions. Other example implementations include implementing one or more of the neural networks in software, which in a further example is executed on a processor having one or more instructions, registers, or other hardware elements configured to facilitate rapid processing of tensors such as neural network inputs, outputs, node coefficients, node connections, and the like.

In one example of operation of a signal processing and/or filtering architecture of FIG. 3, detection neural network 306 may be loaded with pre-determined weights from a trained network configured to perform edge detection in an image. In a typical neural network, activation functions associated with nodes to map input signals received on one layer to output signal provided on another layer are defined by “weights”, which are typically tuned in training operations such as backpropagation. Residual neural network 308 may be loaded with pre-determined weights from a trained neural network designed to smooth edges of an image while scaling the image to a desired resolution.

Detection network 306 in this example may further uses a pre-processed version of input tensor 302 to perform object edge detection, provided via downsample filter 304, semantics neural network 312, and low resolution mesh filter 314, which may also be coupled to detection neural network 306 via upsample and splice filter 316. Base interpolation filter 310 may scale the input 302 to a desired output resolution, such as by performing a simple interpolation to upscale a feature map (e.g., an image captured by a smartphone camera) to a desired final resolution. Output values of detection neural network 306 and residual neural network 308 may be combined by element-wise multiplying them together at multiplier 318, such that the residue or filtering changes produced by the residual neural network 308 are applied only to the edges of objects detected in detection neural network 306. Object-specific changes generated by multiplier 318 may then added to the base image, which has been interpolated to the desired image at 310, at adder 320. A resulting scaled and filtered image may be provided as output tensor 326, along with the object edges detected in detection neural network 306, as selected by multiplexer 324.

In another example, base interpolation 310 output may be coupled to multiplier 322, and assists in performing tasks such as tone mapping or shading. Further, some examples may provide the output of detection neural network 306 as an additional output, allowing subsequent blocks to process the same detected features without having to perform the same detection function. While the downsample 304, semantics neural network 312, and low resolution mesh 314 blocks illustrate one possible application of a processing block, other applications may include providing local histograms, low resolution shading lookup tables, and other such inputs to upsample and splice block 316.

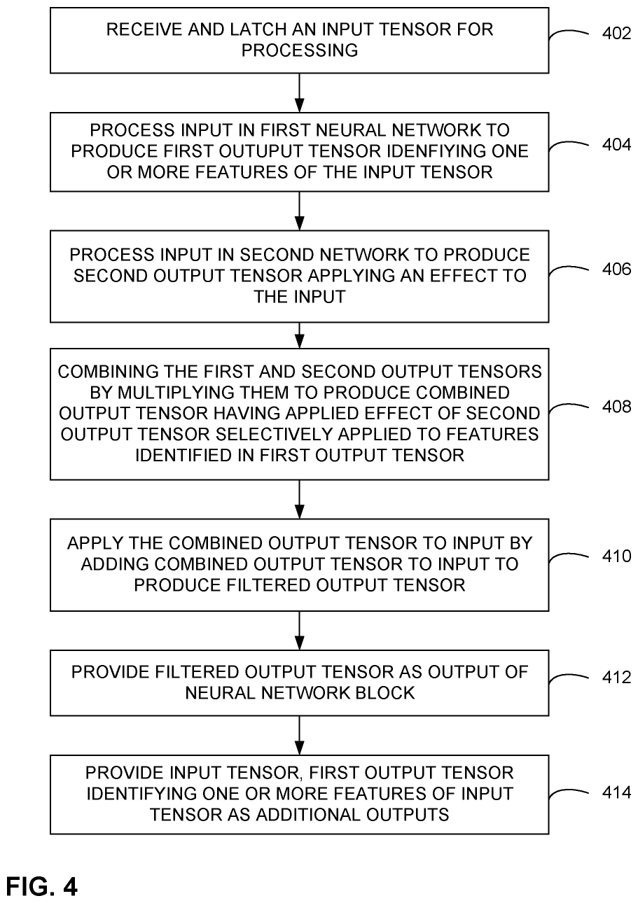

FIG. 4 is a flow diagram of a method of using a signal processing and/or filtering architecture (e.g., implemented by one or more processing stages 202) to process an input tensor, consistent with an example embodiment. Here, an input signal comprising content such as an image, a video frame, audio, a natural language speech sequence, or other content may be provided as an input tensor to a signal processing and/or filtering architecture (e.g., implemented by one or more processing stages 202).

At 402, an input tensor is received and latched in the neural network block, temporarily storing the input tensor for use in various elements of the neural network block. The input tensor in this example comprises an image, such as a photograph or a frame of a video, but in other examples is any other type of data that a neural network can process to produce a useful result, such as audio or a natural language speech sequence.

The latched input is provided to a first neural network at 404, which processes the input tensor to produce a first output tensor identifying one or more features of the input tensor. In image processing examples such as that of FIG. 4, features can include image features such as an edge, a sampling artifact, noise, color banding, mosaicing or other compression artifacts, objects such as faces, object edges or other features. The features may be identified in an output tensor, such as by indicating a location of detected features in an image in an output tensor with different tensor values (e.g. a “1”) than areas of the image that do not have the features (e.g. a “0”). Tensor values in a more complex example comprise zero for pixels or image areas that do not have the features and a number such as an integer or real number that indicates the degree to which a feature is present in a pixel or image area that has the feature. Producing the first output tensor in this manner facilitates later manipulation of only those areas of the image in which the detected image features are present.

The latched input is also provided to a second neural network at 406, which in a further example happens in parallel with the input tensor processing in the first neural network at 404. The second neural network applies an effect to the input tensor that in this example comprises image data, such as de-noising, de-mosaicing, de-banding, blending, sharpening, color grading, tone mapping, or other such image filtering or processing. The output tensor provided by the second neural network comprises a reside or changes that are to be applied to the input image tensor to impart the effect or filter to the image, such as zeros in image or pixel locations where the image remains unchanged and values in other locations that are to be applied to the original image luminance, color, or other values to impart the desired effect.

At 408, the first and second output tensors are combined, to selectively impart the effect encoded in the second output tensor to features identified in the first output tensor. In a more detailed example, this comprises element-wise multiplying the first output tensor by the second output tensor, producing a product that encodes the effect to be applied to the original image only in those areas of the image in which the identified feature is present. Because the first neural network's output tensor in this example identifies features of the input tensor by using non-zero values to indicate the feature's presence or degree, multiplying the first neural network's output tensor by the second neural network's output tensor imparting an effect or filtering the input tensor results in a an output tensor product that comprises application of the effect or filter to only those areas of the input tensor image in which the features of interest are present.

The product of the first and second output tensors in this example comprises a change to be made to the original input tensor to impart the desired effect to the identified features, and does not directly comprise the input tensor itself or a modified version of the input tensor. The combined product output tensor produced at 408 is therefore applied to the original input tensor at 410, such as by adding the combined product output tensor to the original input tensor. The result is the original input tensor latched at 402, such as an original image, with the effect produced by the second neural network at 406 applied to only the features of the original image identified by the first neural network at 404, produced as a sum or a filtered output tensor.

The filtered output tensor produced at 410 is then provided as an output of the CollapseNet neural network block at 412, and in a further example one or more additional outputs or output tensors are provided at 414 such as the original and unfiltered input tensor, the first output tensor generated at 404 that identifies one or more features of the input tensor, or another output that may be useful for future neural network blocks or other processes to employ, such as to avoid duplication of effort in identifying input tensor features or to apply additional filtering based on the original image rather than a filtered image.

In a further example, one or more additional neural networks are employed, such as to find different input tensor features using a neural network other than the first neural network at 404, or to perform different filtering or processing of the input tensor than the second network at 406. In one such example, the first neural network is replaced by a pair of networks, where one is optimized for vertical edge detection and the other is optimized for horizontal edge detection. The results of each of these two feature detection neural networks are added together to produce the first output tensor identifying edges of features in an input image tensor. In another example, different filters are applied to an input image where different features are present, such as applying a de-blocking filter to an image except where the first neural network detected edges of objects, and applying an edge interpolation filter to the image where the first neural network detected edges.

In some examples, a neural network may comprise a graph comprising nodes to model neurons in a brain. In this context, a “neural network” means an architecture of a processing device defined and/or represented by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

In one example embodiment, edges in a neural network connecting nodes may model synapses capable of transmitting signals (e.g., represented by real number values) between neurons. Responsive to receipt of such a signal, a node/neural may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In an implementation, transmission of an output signal from a node in a neural network may be inhibited if a strength of the output signal does not exceed a threshold value.

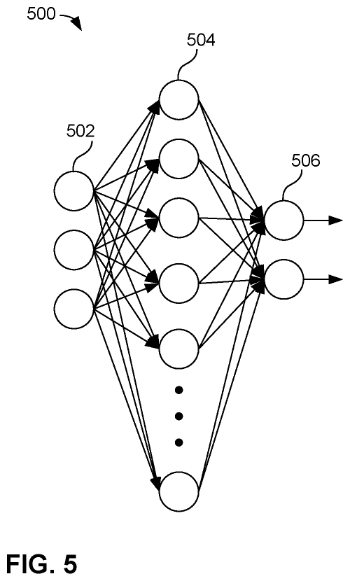

FIG. 5 is a schematic diagram of a neural network 500 formed in “layers” in which an initial layer is formed by nodes 502 and a final layer is formed by nodes 506. All or a portion of features of neural network 500 may be implemented various embodiments of systems described herein. Neural network 500 may include one or more intermediate layers, shown here by intermediate layer of nodes 504. Edges shown between nodes 502 and 504 illustrate signal flow from an initial layer to an intermediate layer. Likewise, edges shown between nodes 504 and 506 illustrate signal flow from an intermediate layer to a final layer. Although FIG. 5 shows each node in a layer connected with each node in a prior or subsequent layer to which the layer is connected, i.e., the nodes are fully connected, other neural networks will not be fully connected but will employ different node connection structures. While neural network 500 shows a single intermediate layer formed by nodes 504, it should be understood that other implementations of a neural network may include multiple intermediate layers formed between an initial layer and a final layer.

According to an embodiment, a node 502, 504 and/or 506 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect.

Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” as referred to herein means an expression of one or more activation input values according to a particular structure, dimension and/or format. Likewise in this context, an “activation output tensor” as referred to herein means an expression of one or more activation output values according to a particular structure, dimension and/or format.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another class of layered neural network may comprise a recursive neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques to iteratively update neural network weights to be associated with nodes and/or edges of a neural network based, at least in part on “training sets.” Such training sets may include training measurements and/or observations to be supplied as input values that are paired with “ground truth” observations or expected outputs. Based on a comparison of such ground truth observations and associated prediction values generated based on such input values in a training process, weights may be updated according to a loss function using backpropagation.

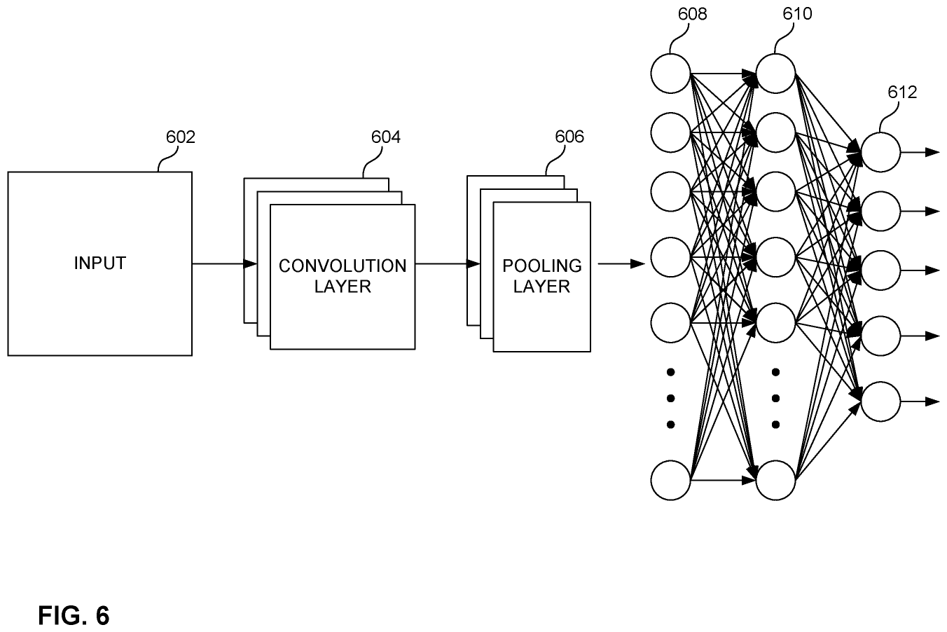

The neural networks employed in various examples can be any known or future neural network architecture, including traditional feed-forward neural networks, convolutional neural networks, or other such networks. FIG. 6 shows a convolutional neural network, including a fully-connected feed-forward section configured to classify an input, consistent with an example embodiment. A convolutional neural network is configured to recognize the importance of information in one input region relative to inputs in other input regions, such as the pixels around an object being filtered rather than pixels in a remote part of the image. Because spatial and temporal relatedness are built in to various convolutional neural network configurations, the convolutional neural network does not have to learn the importance of this relatedness as it would in a simple flattened backpropagation neural network and is more efficient.

In FIG. 6, the input 602 comprises an image which in this example is a 256×256 image in an RGB color space, having pixel locations arranged in a two-dimensional grid with three channels of color intensity or brightness (one channel each for red, green, and blue light). When performing image processing functions such as sharpening, blurring, de-noising, or the like, pixels immediately surrounding an image area being altered are most relevant to alteration of the image area, as are pixels in corresponding locations in each of the three color channels.

Convolution layer 604 comprises a kernel value derived from the image for the kernel region surrounding pixels in the original image, such as using a kernel filter of nine pixels configured to include each original pixel as well as the eight pixels surrounding the original pixel in a 3×3 matrix. As the kernel filter is swept across the original image, an element-wise multiplication of the kernel filter and the image values is performed for each location, and a sum of each element in the product matrix is stored in the convolution layer 604. The kernel filter in some examples will weight each element equally, such as by having ones as multipliers in each element of the 3×3 kernel filter, but in other examples will weight elements differently by having different multipliers for different elements. Because the original image provided as an input at 602 is 256'256 and it is swept by a kernel filter of 3×3 that does not sweep outside the bounds of the original image, the output stored in convolution layer 604 is a matrix of size 254×254 in three channels. In another example, the original image is padded on all sides with a value such as zeros or with repeated border values to increase the input size to 258×258 before sweeping with the 3×3 kernel filter, resulting in an output stored in convolution layer 604 of 256×256 (the original input size). In some alternate examples, the three channels representing red, blue, and green colors are combined in a single channel, or in a fourth channel in addition to the three color channels.

Pooling layer 606 is configured to reduce the spatial size of the convolved features in convolution layer 604, which provides the benefit of reducing the computational power required to process the data. Pooling again involves sweeping the prior data structure with a kernel to produce a new data structure, such as sweeping the convolution layer matrix 604 with a 3×3 kernel. Common pooling algorithms include max pooling, in which the maximum value in the 3×3 kernel or window sweeping the convolution layer is recorded for each windowed location in the convolution layer, and average pooling, in which the average value in the 3×3 kernel sweeping the convolution layer is recorded for each swept location. Max pooling removes noise from data well, and is often preferred over average pooling in which dimensionality reduction is the primary effect.

The kernel in the pooling step in some examples is of different size than the kernel in the convolution layer step, and in another example strides or sweeps across the input data matrix by more than one element at a time. In one such example a 2×2 kernel is used in the pooling step, with a stride of two in each dimension, such that each data element in the convolution layer contributes to only one element in the pooling layer which is approximately one-fourth the size of the convolution layer. In further examples, one or more additional layers or variations on the convolution layer and/or the pooling layer are employed, and may be beneficial to reducing the computational power needed to recognize various elements or features in the input data 602. For example, the convolution and pooling layers may be repeated to further reduce the input data before further processing.

The pooling layer 606 is then flattened in flattened layer 608, for processing in a traditional feed-forward neural network comprising one or more intermediate layers as shown at 610. In a more detailed example, the feed-forward layers are fully connected, meaning each node in an intermediate layer is connected to each node in preceding and subsequent layers, and uses a nonlinear activation function such as the ReLU (rectified linear) or similar activation function. In other examples, the feed-forward layers are not fully connected, but use other node connection topologies.

The output 612 in the example of FIG. 6 comprises a soft-max activation function, in which the input image at 602 is classified as being one of five different possible outputs, such as an image of the letter A, B, C, D, or E. Practical convolutional neural networks often have significantly larger inputs and outputs than the example presented, here, and can perform more complex recognition or other filtering tasks at the expense of greater network complexity.

The convolutional neural network's input, output, and intermediate data sets are often referred to as “tensors”, which can have multiple dimensions or “ranks” depending on the data type, dimensionality, and number of channels in the data set. Vectors within a tensor represent related data elements, such as data set of 100 stocks having 365 daily closing prices in which 100 vectors of 365 elements each are stored in a 100×365 tensor denoted as (100,365). Complex data such as video may have many dimensions of related data, such as where a two-dimensional image of 1920×1080 plus color depth of 256 plus frame number in the video sequence of 10,000 comprise a four dimensional tensor (10000,1920,1080,256). Examples such as these illustrate the benefit of feature recognition and data reduction in a convolutional neural network before processing in a feed-forward neural network to make efficient use of processing power.

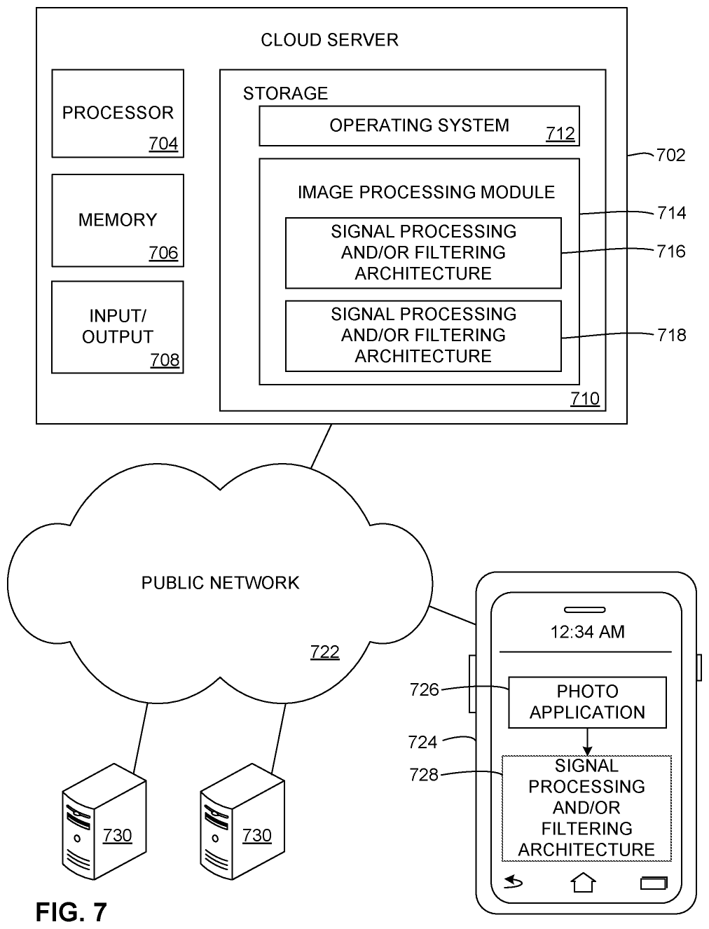

FIG. 7 shows a computing environment in which one or more signal processing and/or filtering architectures (e.g., implemented by one or more processing stages 202, FIG. 2) may be employed, consistent with an example embodiment. Here, a cloud server 702 includes a processor 704 operable to process stored computer instructions, a memory 706 operable to store computer instructions, values, symbols, parameters, etc., for processing on the cloud server, and input/output 708 such as network connections, wireless connections, and connections to accessories such as keyboards and the like. Storage 710 may be nonvolatile, and may store values, parameters, symbols, content, code, etc., such as code for an operating system 712 and code for software such as image processing module 714. Image processing module 714 may comprise multiple signal processing and/or filtering architectures 716 and 718, which may be operable to process input signals such as images. Signal processing and/or filtering architectures may be available for processing images or other content stored on a server, or for providing remote service or “cloud” service to remote computers such as computers 730 connected via a public network 722 such as the Internet.

Smartphone 724 may also be coupled to a public network in the example of FIG. 7, and may include a photo application 726 that utilizes signal processing and/or filtering architecture 728 for in-camera image processing on photos taken with the smart phone's camera via photo application 726. In a further example, a signal processing and/or filtering architecture may process content from more than one image on smartphone 724, such as combining image content from sequential images taken with the same camera or combining images captured by multiple cameras on smartphone 724. Processing multiple images in one example may provide for greater dynamic range, greater resolution, or other advantages over taking a single image with a smartphone camera. In another example, signal processing and/or filtering architecture 728 may be used by one or more applications to process stored images, such as filtering or modifying a stored image to reduce noise, change brightness or contrast, or filter a face or other image object to improve its appearance. Signal processing and/or filtering architectures 716, 718, and 728 may provide faster and more efficient computation of such effects in an environment such as a smartphone, and can provide for longer battery life due to reduction in power needed to impart a desired effect and/or compute a result.

In another example, a device such as smartphone 724 may use a dedicated signal processing and/or filtering architecture 728 for some tasks, such as relatively simple filters or image processing that do not require substantial computational resources or electrical power such as de-noising or blending, and offloads other processing tasks to a signal processing and/or filtering architecture 716 or 718 of cloud server 702 for more complex tasks such as facial recognition and filtering.

Signal processing and/or filtering architectures 716, 718, and 728 of FIG. 7 may, in some examples, be implemented in software, where various nodes, tensors, and other elements of processing stages (e.g., processing stages 202) may be stored in data structures in a memory such as 706 or storage 710. In other examples, signal processing and/or filtering architectures 716, 718, and 728 may be implemented in hardware, such as a convolutional neural network structure that is embodied within the transistors, resistors, and other elements of an integrated circuit. In an alternate example, signal processing and/or filtering architectures 716, 718 and 728 may be implemented in a combination of hardware and software, such as a neural processing unit (NPU) having software-configurable weights, network size and/or structure, and other such configuration parameters.

Processing stages 202 (FIG. 2) and/or a signal processing and/or filtering architecture in FIG. 3, as described herein in particular examples, may be formed in whole or in part by and/or expressed in transistors and/or lower metal interconnects (not shown) in processes (e.g., front end-of-line and/or back-end-of-line processes) such as processes to form complementary metal oxide semiconductor (CMOS) circuitry. The various blocks, neural networks, and other elements disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

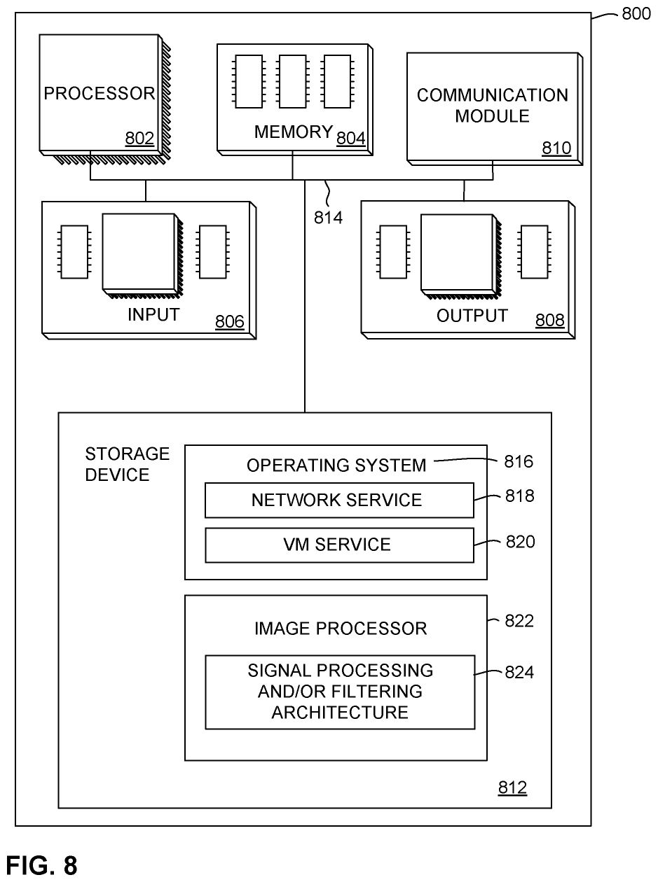

Computing devices such as cloud server 702, smartphone 724, and other such devices that may employ signal processing and/or filtering architectures can take many forms and can include many features or functions including those already described and those not described herein. FIG. 8 shows a block diagram of a general-purpose computerized system, consistent with an example embodiment. FIG. 8 illustrates only one particular example of computing device 800, and other computing devices 800 may be used in other embodiments. Although computing device 800 is shown as a standalone computing device, computing device 800 may be any component or system that includes one or more processors or another suitable computing environment for executing software instructions in other examples, and need not include all of the elements shown here.

As shown in the specific example of FIG. 8, computing device 800 includes one or more processors 802, memory 804, one or more input devices 806, one or more output devices 808, one or more communication modules 810, and one or more storage devices 812. Computing device 800, in one example, further includes an operating system 816 executable by computing device 800. The operating system includes in various examples services such as a network service 818 and a virtual machine service 820 such as a virtual server. One or more applications, such as image processor 822 are also stored on storage device 812, and are executable by computing device 800.

Each of components 802, 804, 806, 808, 810, and 812 may be interconnected (physically, communicatively, and/or operatively) for inter-component communications, such as via one or more communications channels 814. In some examples, communication channels 814 include a system bus, network connection, inter-processor communication network, or any other channel for communicating data. Applications such as image processor 822 and operating system 816 may also communicate information with one another as well as with other components in computing device 800.

Processors 802, in one example, are configured to implement functionality and/or process instructions for execution within computing device 800. For example, processors 802 may be capable of processing instructions stored in storage device 812 or memory 804. Examples of processors 802 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 812 may be configured to store information within computing device 800 during operation. Storage device 812, in some examples, is known as a computer-readable storage medium. In some examples, storage device 812 comprises temporary memory, meaning that a primary purpose of storage device 812 is not long-term storage. Storage device 812 in some examples is a volatile memory, meaning that storage device 812 does not maintain stored contents when computing device 800 is turned off. In other examples, data is loaded from storage device 812 into memory 804 during operation. Examples of volatile memories include random access memories (RAM), dynamic random access memories (DRAM), static random access memories (SRAM), and other forms of volatile memories known in the art. In some examples, storage device 812 is used to store program instructions for execution by processors 802. Storage device 812 and memory 804, in various examples, are used by software or applications running on computing device 500 such as image processor 822 to temporarily store information during program execution.

Storage device 812, in some examples, includes one or more computer-readable storage media that may be configured to store larger amounts of information than volatile memory. Storage device 812 may further be configured for long-term storage of information. In some examples, storage devices 812 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 800, in some examples, also includes one or more communication modules 810. Computing device 800 in one example uses communication module 810 to communicate with external devices via one or more networks, such as one or more wireless networks. Communication module 810 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 800 uses communication module 810 to wirelessly communicate with an external device such as via public network 722 of FIG. 7.

Computing device 800 also includes in one example one or more input devices 806. Input device 806, in some examples, is configured to receive input from a user through tactile, audio, or video input. Examples of input device 806 include a touchscreen display, a mouse, a keyboard, a voice responsive system, video camera, microphone or any other type of device for detecting input from a user.

One or more output devices 808 may also be included in computing device 800. Output device 808, in some examples, is configured to provide output to a user using tactile, audio, or video stimuli. Output device 808, in one example, includes a display, a sound card, a video graphics adapter card, or any other type of device for converting a signal into an appropriate form understandable to humans or machines. Additional examples of output device 808 include a speaker, a light-emitting diode (LED) display, a liquid crystal display (LCD or OLED), or any other type of device that can generate output to a user.

Computing device 800 may include operating system 816. Operating system 816, in some examples, controls the operation of components of computing device 800, and provides an interface from various applications such as image processor 822 to components of computing device 800. For example, operating system 816, in one example, facilitates the communication of various applications such as image processor 822 with processors 802, communication unit 810, storage device 812, input device 806, and output device 808. Applications such as image processor 822 may include program instructions and/or data that are executable by computing device 500. As one example, image processor 822 may implement a signal processing and/or filtering architecture 824 to perform image processing tasks such as those described above, which in a further example comprises using signal processing and/or filtering hardware elements such as those described in the above examples. These and other program instructions or modules may include instructions that cause computing device 800 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

Features of example computing devices in FIGS. 7 and 8 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 4 and in the text associated with the foregoing figure(s) of the present patent application.

The term electronic file and/or the term electronic document, as applied herein, refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

1. A method comprising:
executing a first neural network to generate a first output tensor based, at least in part, on an input tensor, the first output tensor comprising values to impart an effect to one or more features in the input tensor;
executing a second neural network to generate a second output tensor based on the input tensor; and
modulating the effect to be imparted to the one or more features based, at least in part, on the second output tensor.

2. The method of claim 1, wherein the effect comprises tone mapping, color grading, mesh shading, de-mosaicing or de-noising, super-resolution, or a combination thereof.

3. The method of claim 1, wherein the second output tensor comprises coefficients based, at least in part, on detection of at least one of the one more features in the input tensor.

4. The method of claim 3, wherein modulating the effect to be imparted to the one or more features further comprises applying the coefficients to the first output tensor to compute residual values, and combining the computed residual values with the input tensor or a tensor derived from the first input tensor to impart the effect.

5. The method of claim 1, wherein the input tensor is determined based, at least in part, on image intensity values of one or more image frames.

6. The method of claim 1, wherein at least one of the first neural network and the second neural network comprise convolutional neural networks.

7. The method of claim 1, further comprising a third neural network to generate a third output tensor based, at least in part, on the input tensor, wherein the effect to be imparted to the one or more features is based, at least in part, on at least one of the first output tensor and the third output tensor as selectively determined by the second output tensor.

8. The method of claim 1, further comprising multiplying one or more values in the first output tensor by one or more values in the second output tensor to produce a product tensor, and adding the product tensor to the input tensor or a tensor derived from the first input tensor.

9. The method of claim 1, wherein the executing the first neural network, executing the second neural network, and modulating the effect are employed to form one or more layers of a larger network architecture.

10. A computing device, comprising:
a memory comprising one more storage devices; and
one or more processors coupled to the memory, the one or more processors operable to:
execute a first neural network to process an input tensor to produce a first output tensor, the first output tensor to indicate one or more detected features in the input tensor;
execute a second neural network to process the input tensor to produce a second output tensor comprising an effect applied to the input tensor;
apply the effect of the second output tensor to the one or more detected features in the first output tensor to produce a combined output tensor; and
apply the combined output tensor to the input tensor.

11. The computing device of claim 10, wherein the one or more processors are further operable to multiply the first output tensor by the second output tensor to produce the combined output tensor.

12. The computing device of claim 10, wherein the one or more processors are further operable to add the combined output tensor to the input tensor to produce a processing unit output.

13. The computing device of claim 10, wherein the first output tensor comprises coefficients based, at least in part, on detection of at least one of the one more features in the input tensor.

14. The computing device of claim 10, wherein the input tensor is derived, at least in part, on image signal intensity values of one or more image frames.

15. The computing device of claim 10, wherein the first neural network or the second neural network, or a combination thereof, comprise a convolutional neural network.

16. The computing device of claim 10, wherein the one or more processors are further operable to execute a third neural network to generate a third output tensor based, at least in part, on the input tensor, wherein the effect to be imparted to the one or more detected features is based, at least in part, on the second output tensor or the third output tensor, or a combination thereof, as selectively determined by the first output tensor.

17. The computing device of claim 10, wherein the effect applied in the second neural network comprises tone mapping, color grading, mesh shading, de-mosaicing or de-noising, super-resolution, or a combination thereof.

18. A computer-readable medium with instructions stored thereon, the instructions to be executable by one or more processors to cause a computerized system to:
execute a first neural network to generate a first output tensor based on an input tensor, the first output tensor comprising values to impart an effect to one or more features in the input tensor;
execute a second neural network to generate a second output tensor based on the input tensor; and
modulate the effect to be imparted to the one or more features based, at least in part, on the second output tensor.

19. The computer-readable medium of claim 18, wherein the effect comprises tone mapping, color grading, mesh shading, de-mosaicing or de-noising, super-resolution, or a combination thereof.

20. The computer-readable medium of claim 18, wherein the instructions to be further executable by the one or more processors to modulate the effect to be imparted to the one or more features based, at least in part, on:
application of coefficients in the second output tensor to the first output tensor to compute residual values, and
combination of the computed residual values with the input tensor to impart the effect.
